(19) United States
(12) Patent Application Publication
(10) Pub. No.: US 2021/0160801 A1
(43) Pub. Date: May 27, 2021

(54) APPARATUS AND METHOD FOR EXTRACTING UPLINK AND DOWNLINK SYNCHRONIZATION FOR RELAY IN COMMUNICATION NETWORK

(71) Applicant: FRTEK CO., LTD, Anyang-si (KR)

(72) Inventors: Byoung Chul LIM, Seongnam-si (KR); Young Jun WON, Suwon-si (KR); Young Jin LEE, Suwon-si (KR); Jun Sung PARK, Incheon (KR); Sang Hyup LEE, Seoul (KR)

(21) Appl. No.: 16/698,702

(22) Filed: Nov. 27, 2019

(30) Foreign Application Priority Data
Nov. 27, 2019 (KR) 10-2019-0154316

(51) Int. Cl. H04W 56/00; H04L 7/00

(52) U.S. Cl. CPC H04W 56/0015; H04B 7/155; H04L 7/0087

(57) ABSTRACT

Disclosed are an apparatus and method for extracting synchronization by acquiring a boundary between uplink and downlink signals in 5G networks. In an embodiment, the synchronization extracting apparatus may include a reference detector and a synchronization extractor. The reference detector detects a start position of a radio frame from a signal broadcasted by a base station. The synchronization extractor collects resource allocation information and extracts synchronization by acquiring a boundary between an uplink (UL) signal and a downlink (DL) signal from the resource allocation information, based on the start position of the radio frame. The resource allocation information indicates information about arrangement of the UL signal and the DL signal in the radio frame. Other embodiments are possible.

### CROSS REFERENCE TO RELATED APPLICATIONS

The present application claims priority to Korean Patent Application No. 10-2019-0154316, filed on Nov. 27, 2019, the content of which is incorporated herein by reference in its entirety.

### TECHNICAL FIELD

The present disclosure relates to a synchronization extraction technique and, more particularly, to an apparatus and method for extracting synchronization by acquiring a boundary between uplink and downlink signals in 5G networks of non-standalone (NSA) and standalone (SA).

### BACKGROUND

In communication systems, a repeater is located between a base station (e.g., gNB) and a user terminal (e.g., user equipment (UE)) and relays downlink (DL) and uplink (UL) signals between the base station and the user terminal. The fifth-generation (5G) communication system uses a time division duplex (TDD) scheme rather than a frequency division duplex (FDD) scheme. Thus, a radio frequency (RF) repeater used for the 5G system is required to switch DL/UL signals at the same timing as that of the base station.

In a typical FDD-based system, the repeater needs no separate synchronization module for synchronizing with the base station because DL/UL frequencies are separated. However, in the TDD-based system, the repeater needs a 5G modem and an LTE modem to obtain synchronization for a boundary between DL and UL signals. Using the 5G modem and the LTE modem allows extraction of a synchronization signal. However, using such modems in the repeater other than the user terminal may cause a very great burden of costs in actual.

### SUMMARY

Accordingly, the present disclosure provides an apparatus and method for extracting synchronization for a boundary between uplink and downlink signals, without an LTE modem and a 5G modem, to switch the downlink and uplink signals in a time division duplex (TDD) communication system. This allows network construction costs to be significantly reduced.

According to embodiments of the present disclosure, a synchronization extracting apparatus may include a reference detector and a synchronization extractor. The reference detector detects a start position of a radio frame from a signal broadcasted by a base station. The synchronization extractor collects resource allocation information and extracts synchronization by acquiring a boundary between an uplink (UL) signal and a downlink (DL) signal from the resource allocation information, based on the start position of the radio frame. The resource allocation information indicates information about arrangement of the UL signal and the DL signal in the radio frame.

The resource allocation information may be received from a management server or entered by a manager directly or through firmware.

The management server may be one of an element management system (EMS) and a self-optimization network (SON) server.

The resource allocation information may include at least one of a number of DL slots, a number of DL symbols, a number of UL slots, a number of UL symbols, a time division duplex (TDD) transmission periodicity, and an absolute radio-frequency channel number (ARFCN).

The resource allocation information may include at least one of a periodicity of a DL-UL pattern (dl-UL-TransmissionPeriodicity), a number of consecutive full DL slots at a beginning of each DL-UL pattern (nrofDownlinkSlots), a number of consecutive DL symbols in a beginning of a slot following a last full DL slot (nrofDownlinkSymbols), a number of consecutive full UL slots at an end of each DL-UL pattern (nrofUplinkSlots), and a number of consecutive UL symbols in an end of a slot preceding a first full UL slot (nrofUplinkSymbols).

The reference detector may synchronize with a specific cell for which a synchronization signal is detected, extract a master information block (MIB) by decoding a physical broadcast channel (PBCH) of the specific cell, and detect the start position of the radio frame through information contained in the MIB.

The apparatus may be a field programmable gate array (FPGA).

The apparatus may further include a first antenna, a second antenna, a switch, a DL processor, an UL processor, and a switching controller. The first antenna communicates with the base station. The second antenna communicates with a user terminal. The switch connects the first and second antennas to the DL processor or the UL processor. The DL processor receives the DL signal from the base station through the first antenna, amplifies the received DL signal by adjusting a gain, and then transmits the amplified DL signal to the user terminal through the second antenna. The UL processor receives the UL signal from the user terminal through the second antenna, amplifies the received UL signal by adjusting a gain, and then transmits the amplified UL signal to the base station through the first antenna. The switching controller controls the switch in accordance with the synchronization extracted by the synchronization extractor so as to connect the first antenna, the DL processor, and the second antenna in a DL symbol section and so as to connect the first antenna, the UL processor, and the second antenna in an UL symbol section.

According to embodiments of the present disclosure, a synchronization extracting method may include, at a reference detector, detecting a start position of a radio frame from a signal broadcasted by a base station; at a synchronization extractor, collecting resource allocation information that indicates information about arrangement of an uplink (UL) signal and a downlink (DL) signal in the radio frame; and at the synchronization extractor, extracting synchronization by acquiring a boundary between the UL signal and the DL signal from the resource allocation information, based on the start position of the radio frame.

The collecting resource allocation information may include, at the synchronization extractor, receiving the resource allocation information corresponding to a synchronization signal block index from a management server; or at the synchronization extractor, receiving the resource allocation information entered by a manager directly or through firmware.

The management server may be one of an element management system (EMS) and a self-optimization network (SON) server.

The resource allocation information may include at least one of a number of DL slots, a number of DL symbols, a number of UL slots, a number of UL symbols, a time division duplex (TDD) transmission periodicity, and an absolute radio-frequency channel number (ARFCN).

The resource allocation information may include at least one of a periodicity of a DL-UL pattern (dl-UL-TransmissionPeriodicity), a number of consecutive full DL slots at a beginning of each DL-UL pattern (nrofDownlinkSlots), a number of consecutive DL symbols in a beginning of a slot following a last full DL slot (nrofDownlinkSymbols), a number of consecutive full UL slots at an end of each DL-UL pattern (nrofUplinkSlots), and a number of consecutive UL symbols in an end of a slot preceding a first full UL slot (nrofUplinkSymbols).

The detecting a start position of a radio frame may include, at the reference detector, synchronizing with a specific cell for which a synchronization signal is detected; at the reference detector, extracting a master information block (MIB) by decoding a physical broadcast channel (PBCH) of the specific cell; and at the reference detector, detecting the start position of the radio frame through information contained in the MIB.

The reference detector and the synchronization extractor may be implemented through a field programmable gate array (FPGA).

The method may further include, at a switching controller, controlling the switch in accordance with the synchronization extracted by the synchronization extractor to connect a first antenna, a DL processor, and a second antenna in a DL symbol section such that the DL processor receives the DL signal from the base station through the first antenna and transmits the received DL signal to a user terminal through the second antenna, and to connect the first antenna, an UL processor, and the second antenna in an UL symbol section such that the UL processor receives the UL signal from the user terminal through the second antenna and transmits the received UL signal to the base station through the first antenna.

### BRIEF DESCRIPTION OF THE DRAWINGS

FIG. 1 is a diagram illustrating a wireless communication system according to an embodiment of the present disclosure.

FIGS. 2 and 3 are diagrams illustrating a structure of a frame used in a wireless communication system according to an embodiment of the present disclosure.

FIG. 4 is a diagram illustrating a configuration of a repeater according to an embodiment of the present disclosure.

FIG. 5 is a flow diagram illustrating a synchronization extracting method according to an embodiment of the present disclosure.

FIG. 6 is a flow diagram illustrating a method for detecting a frame start position according to an embodiment of the present disclosure.

### DETAILED DESCRIPTION

Hereinafter, embodiments of the present disclosure will be described in detail with reference to the accompanying drawings. The present disclosure may, however, be embodied in many different forms and should not be construed as being limited to the embodiments set forth herein. Rather, these embodiments are provided so that the disclosure will be thorough and complete and will fully convey the scope of the disclosure to those skilled in the art.

In the following description of embodiments, techniques that are well known in the art and not directly related to the present disclosure are not described. This is to clearly convey the subject matter of the present disclosure by omitting an unnecessary explanation. For the same reason, some elements in the drawings are exaggerated, omitted, or schematically illustrated. Also, the size of each element does not entirely reflect the actual size. In the disclosure, the same or corresponding elements are denoted by the same reference numerals.

A wireless communication system to which various embodiments of the present disclosure are applied is the fifth-generation (5G) communication system. The present disclosure is, however, not limited to the 5G communication system and, as being apparent to those skilled in the art, may be also applied to any communication system that performs communication by distinguishing between uplink (UL) and downlink (DL) through a time division duplex (TDD) scheme.

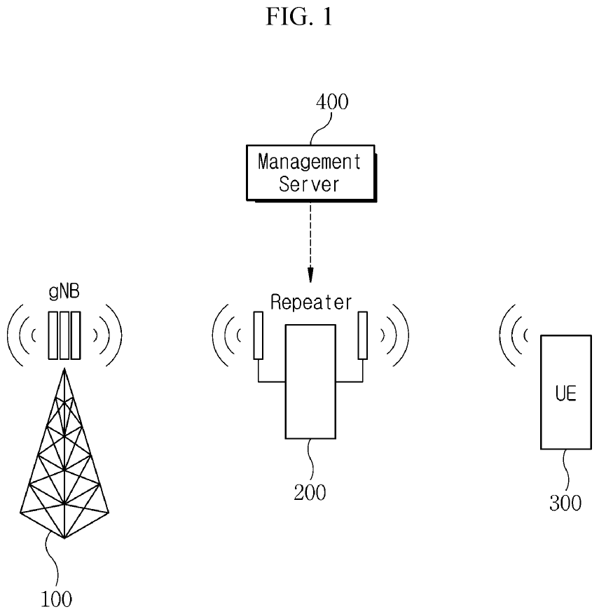

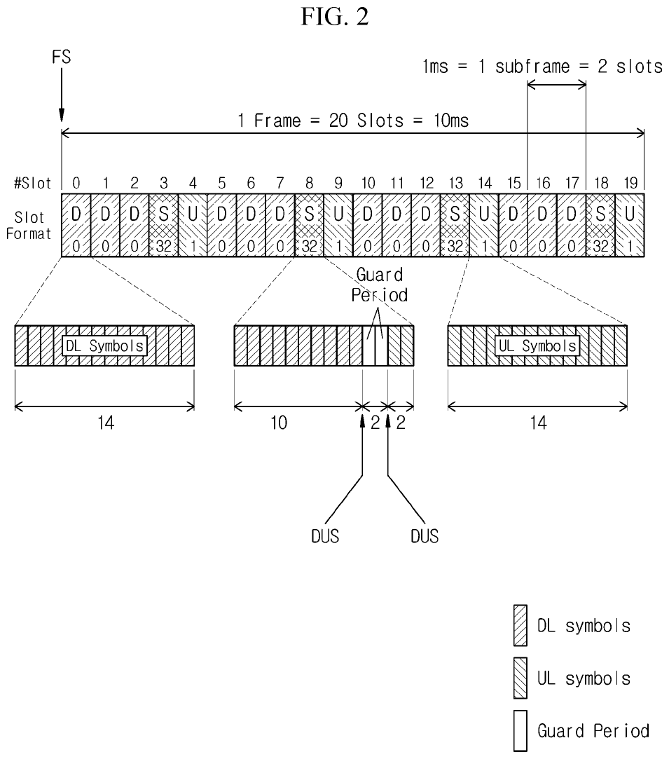

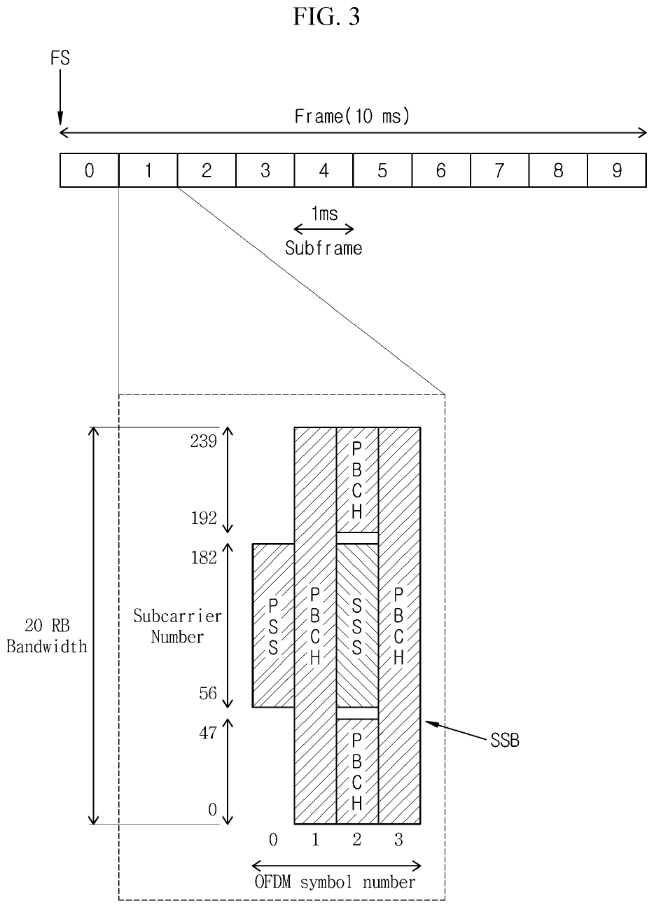

At the outset, a wireless communication system to which embodiments of the present disclosure are applied will be described. FIG. 1 is a diagram illustrating a wireless communication system according to an embodiment of the present disclosure. FIGS. 2 and 3 are diagrams illustrating a structure of a frame used in a wireless communication system according to an embodiment of the present disclosure.

Referring to FIG. 1, the wireless communication system according to an embodiment includes a base station 100 (e.g., gNB), a repeater 200, and a user terminal 300 (e.g., user equipment (UE)). Optionally, the wireless communication system may further include a management server 400.

The base station 100 may transmit a broadcast signal at predetermined intervals such that the user terminal 300 may search for a cell and synchronize with the base station 100. The user terminal 300 may receive the broadcast signal from the base station 100 and acquire synchronization of the base station 100 from the broadcast signal. Then, based on the acquired synchronization, the user terminal 300 may perform communication with the base station 100. That is, the base station 100 transmits a downlink (DL) signal to the user terminal 300, and the user terminal 300 transmits an uplink (UL) signal to the base station 100.

The repeater 200 is a radio frequency (RF) repeater and is located between the base station 100 and the user terminal 300. The repeater 200 receives the DL signal from the base station 100 and delivers it to the user terminal 300. In addition, the repeater 200 receives the UL signal from the user terminal 300 and delivers it to the base station 100.

As shown in FIG. 2, the 5G communication system uses a radio frame of 10 milliseconds (ms). For synchronization of such a frame, the 5G communication system provides a primary synchronization signal (PSS), a secondary synchronization signal (SSS), and a physical broadcast channel (PBCH).

The PSS is a physical layer specific signal. The repeater 200 may obtain a radio frame boundary through the PSS. The PSS is an m-sequence which is a special type of linear feedback shift register (LFSR) sequence, and provides the longest non-repeating sequence. The PSS is an m-sequence composed of 127 values and is mapped to 127 active subcarriers around the bottom of the system bandwidth. The PSS is used for frame synchronization and provides the radio frame boundary, that is, the position of the first symbol in the radio frame. In addition, the PSS is an important factor in determining a physical cell identifier (PCI) and provides the value of an NID2 parameter for the calculation of the PCI.

The SSS is a physical layer specific signal. The repeater 200 may obtain a subframe boundary through the SSS. The SSS is also an m-sequence like the PSS. The SSS is an m-sequence composed of 127 values and is mapped to 127 active subcarriers around the bottom of the system bandwidth. The SSS is used for frame synchronization and provides the subframe boundary, that is, the position of the first symbol in the subframe. The SSS is also an important factor in determining the PCI and provides the value of an NID1 parameter for the PCI calculation.

The PBCH is used for delivering system information. Accessing a 5G cell requires to decode information about the PBCH. The PBCH contains DL system bandwidth, timing information of a radio frame, periodicity of a synchronization signal burst set, a system frame number, and other higher layer information.

In particular, as shown in FIG. 3, the 5G communication system uses a time division duplex (TDD) scheme rather than a frequency division duplex (FDD) scheme. In the TDD scheme, one frame includes twenty slots, and 10 ms is allocated. One slot is composed of fourteen symbols. Each of fourteen symbols in each slot is allocated for one of a DL symbol for transmitting a DL signal, an UL symbol for transmitting an UL signal, and a guard period considering a time distinction and a switching time for transmitting the DL signal or the UL signal. Thus, in the TDD based communication, the repeater 200 is required to extract synchronization for a boundary between the UL signal and the DL signal in order to transmit the DL signal and receive the UL signal at the same timing as the base station 100.

Typically, the repeater may receive an RRC connection reconfiguration message by communicating with a core network through a dedicated control channel (DCCH), decode the received message, extract information contained in the decoded message, and acquire synchronization by using the extracted information. This process, however, needs an LTE modem or a 5G modem, which causes a very great burden of costs, thus being almost unrealizable. Therefore, the repeater 200 according to embodiments of the present disclosure does not employ the LTE modem or the 5G modem. Instead, using a field programmable gate array (FPGA), the repeater 200 detects a start position (indicated by ‘FS’ in FIG. 3) of a radio frame from a signal broadcasted by the base station 100. Then, the repeater 200 extracts synchronization for a boundary (indicated by ‘DUS’ in FIG. 3) between a DL signal and an UL signal, based on the frame start position (FS), by using resource allocation information which is information about the arrangement of UL and DL signals in the frame. As such, no use of the LTE modem or 5G modem can reduce related costs.

According to an embodiment, the resource allocation information includes at least one of the number of DL slots, the number of DL symbols, the number of UL slots, the number of UL symbols, a TDD transmission periodicity, and an absolute radio-frequency channel number (ARFCN).

According to another embodiment, the resource allocation information includes the periodicity of the DL-UL pattern (dl-UL-TransmissionPeriodicity), the number of consecutive full DL slots at the beginning of each DL-UL pattern (nrofDownlinkSlots), the number of consecutive DL symbols in the beginning of the slot following the last full DL slot (nrofDownlinkSymbols), the number of consecutive full UL slots at the end of each DL-UL pattern (nrofUplinkSlots), and/or the number of consecutive UL symbols in the end of the slot preceding the first full UL slot (nrofUplinkSymbols).

According to an embodiment, the management server 400 may transmit the resource allocation information corresponding to a synchronization signal block (SSB) index to the repeater 300. The management server 400 may be any one of an element management system (EMS) and a self-optimization network (SON) server. According to another embodiment, a manager may enter the resource allocation information into the repeater 200 directly or through firmware.

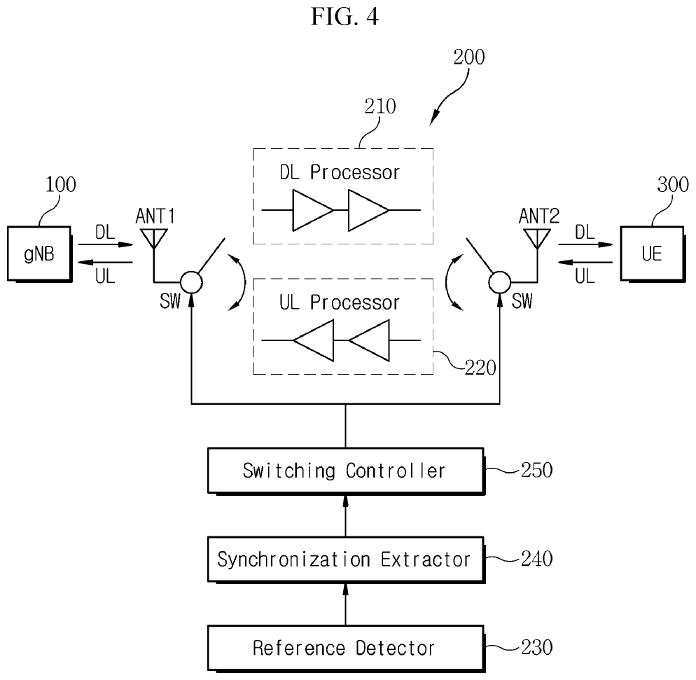

Now, the repeater 200 according to an embodiment of the present disclosure will be described in detail. FIG. 4 is a diagram illustrating a configuration of a repeater according to an embodiment of the present disclosure.

The repeater 200 according to an embodiment includes a DL processor 210, an UL processor 220, a reference detector 230, a synchronization extractor 240, and a switching controller 250. In addition, the repeater 200 further includes a first antenna ANT1, a second antenna ANT2, and a switch SW. The first antenna ANT1 is used for communication with a base station (gNB) 100, and the second antenna ANT2 is used for communication with a user terminal (UE) 300. The switch SW connects the first and second antennas ANT1 and ANT2 to the DL processor 210 or the UL processor 220 under the control of the switching controller 250.

The DL processor 210 receives a DL signal from the base station 100 through the first antenna ANT1, amplifies the received DL signal by adjusting a gain, and then transmits the amplified DL signal to the user terminal 300 through the second antenna ANT2.

The UL processor 220 receives an UL signal from the user terminal 300 through the second antenna ANT2, amplifies the received UL signal by adjusting a gain, and then transmits the amplified UL signal to the base station 100 through the first antenna ANT1.

The reference detector 230 detects a start position of a radio frame from a signal broadcasted by the base station 100. To this end, the reference detector 230 synchronizes with a specific cell for which a synchronization signal (SS, i.e., PSS and SSS) is detected. In this synchronization process, a physical cell identifier (PCI) can be derived. When the synchronization with the specific cell is completed, it is possible to acquire a physical broadcast channel (PBCH) in accordance with the SS because the center frequencies of the primary and secondary synchronization signals (PSS and SSS) are aligned with the center frequency of the PBCH. Then, the reference detector 230 decodes the PBCH and extracts a master information block (MIB) from the decoded PBCH. Therefore, the reference detector 230 can detect the frame start position (FS) through information contained in the MIB.

The synchronization extractor 240 collects resource allocation information that indicates information about the arrangement of the UL and DL signals in the frame. In addition, the synchronization extractor 240 extracts synchronization by acquiring a boundary (DUS) between DL and UL signals from the collected resource allocation information, based on the frame start position (FS) detected by the reference detector 230.

According to an embodiment, the resource allocation information includes at least one of the number of DL slots, the number of DL symbols, the number of UL slots, the number of UL symbols, a TDD transmission periodicity, and an absolute radio-frequency channel number (ARFCN). According to another embodiment, the resource allocation information includes the periodicity of the DL-UL pattern (dl-UL-TransmissionPeriodicity), the number of consecutive full DL slots at the beginning of each DL-UL pattern (nrofDownlinkSlots), the number of consecutive DL symbols in the beginning of the slot following the last full DL slot (nrofDownlinkSymbols), the number of consecutive full UL slots at the end of each DL-UL pattern (nrofUplinkSlots), and/or the number of consecutive UL symbols in the end of the slot preceding the first full UL slot (nrofUplinkSymbols).

According to an embodiment, the synchronization extractor 240 may receive the resource allocation information corresponding to a synchronization signal block (SSB) index from the management server 400. The management server 400 may be any one of an element management system (EMS) and a self-optimization network (SON) server. According to another embodiment, the synchronization extractor 240 may collect the resource allocation information entered by a manager directly or through firmware.

The switching controller 250 controls the switch SW to switch between UL and DL in the TDD scheme in accordance with the synchronization for the boundary between the UL and DL signals extracted by the synchronization extractor 240. That is, based on the synchronization for the boundary between the UL and DL signals, the switching controller 250 controls the switch SW to connect the first antenna ANT1, the DL processor 210, and the second antenna ANT2 in the DL symbol section. Similarly, based on the synchronization for the boundary between the UL and DL signals, the switching controller 250 controls the switch SW to connect the first antenna ANT1, the UL processor 220, and the second antenna ANT2 in the UL symbol section.

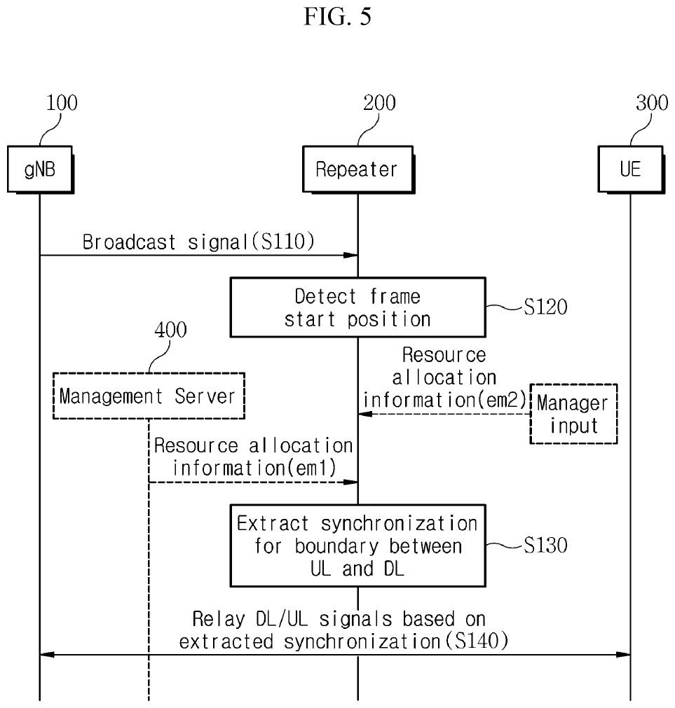

Now, a method for extracting the synchronization by acquiring the boundary between the UL and DL signals will be described in detail. FIG. 5 is a flow diagram illustrating a synchronization extracting method according to an embodiment of the present disclosure.

At step S110, the reference detector 230 of the repeater 200 receives a signal broadcasted by the base station (gNB) 100. Shown in FIG. 2 is an example of this broadcast signal.

Then, at step S120, the reference detector 230 detects a frame start position (FS) and a synchronization signal block (SSB) index from the received signal, based on a primary synchronization signal (PSS), a secondary synchronization signal (SSS), and a physical broadcast channel (PBCH). The SSB index may be an index for distinguishing beams radiated by the base station 100 through a multi-input multi-output (MIMO) antenna.

Next, at step S130, the synchronization extractor 240 of the repeater 200 extracts the synchronization for a boundary (DUS) between UL and DL signals from the resource allocation information, based on the frame start position (FS).

As shown in FIG. 3, the frame contains UL symbols and DL symbols. In embodiments, the resource allocation information indicates information about arrangement of UL and DL signals in the frame. In other words, the resource allocation information allows distinguishing positions of UL and DL slots and positions of UL and DL symbols in the frame. Therefore, using the resource allocation information, the synchronization extractor 240 can acquire the boundary between the UL and DL signals on the basis of the frame start position and thereby extract the synchronization for the boundary.

According to an embodiment (indicated by ‘em1’ in FIG. 5), the management server 400 may provide the resource allocation information corresponding to the SSB index to the synchronization extractor 240. The management server 400 may be any one of an element management system (EMS) and a self-optimization network (SON) server. Therefore, the synchronization extractor 240 may collect the resource allocation information from the management server 400.

According to another embodiment (indicated by ‘em2’ in FIG. 5), a manager may enter the resource allocation information directly or through firmware. Therefore, the synchronization extractor 240 may collect the entered resource allocation information.

Next, at step S140, the switching controller 250 of the repeater 200 controls the switch SW to switch between UL and DL in the TDD scheme in accordance with the synchronization for the boundary between the UL and DL signals extracted by the synchronization extractor 240. Therefore, the repeater 200 may receive the DL signal from the base station 100 and transmit the received DL signal to the user terminal 300, and may also receive the UL signal from the user terminal 300 and transmit the received UL signal to the base station 100.

That is, in accordance with the synchronization for the boundary between the UL and DL signals, the switching controller 250 controls the switch SW to connect the first antenna ANT1, the DL processor 210, and the second antenna ANT2 in the DL symbol section. Then, the DL processor 210 receives the DL signal from the base station 100 through the first antenna ANT1, amplifies the received DL signal by adjusting a gain, and then transmits the amplified DL signal to the user terminal 300 through the second antenna ANT2.

In addition, in accordance with the synchronization for the boundary between the UL and DL signals, the switching controller 250 controls the switch SW to connect the first antenna ANT1, the UL processor 220, and the second antenna ANT2 in the UL symbol section. Then, the UL processor 220 receives an UL signal from the user terminal 300 through the second antenna ANT2, amplifies the received UL signal by adjusting a gain, and then transmits the amplified UL signal to the base station 100 through the first antenna ANT1.

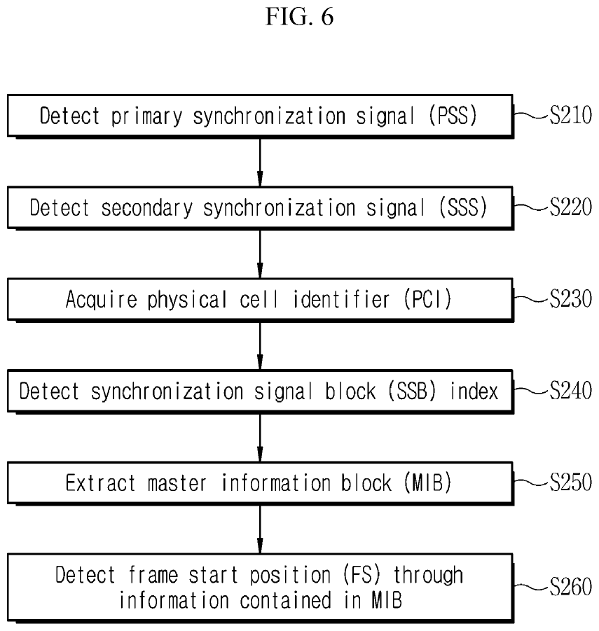

Meanwhile, at the above-described step S120, the repeater 200 detects the frame start position (FS) and the SSB index. This step S120 will be described in more detail. FIG. 6 is a flow diagram illustrating a method for detecting a frame start position according to an embodiment of the present disclosure.

Referring to FIG. 6, at step S210, the reference detector 230 of the repeater 230 detects a primary synchronization signal (PSS) from a signal (i.e., SSB) broadcasted by the base station 100 and detects the value of Nid2 parameter. For example, by correlating the signal received from the base station 100 with a PSS sequence, the value of Nid2 parameter may be detected.

In addition, at step S220, the reference detector 230 detects a secondary synchronization signal (SSS) from the signal broadcasted by the base station 100 and detects the value of Nid1 parameter. For example, by correlating the signal received from the base station 100 with an SSS sequence, the value of Nid1 parameter may be detected.

Then, at step S230, the reference detector 230 acquires a physical cell identifier (PCI) through Equation 1 given below by inputting the detected values of Nid1 and Nid2.

Nid(Cell)=3Nid1+Nid2 [Equation 1]

In Equation 1, Nid(Cell) denotes the PCI.

As such, the reference detector 230 detects and decodes the synchronization signal (SS) (i.e., PSS and SSS) at steps S210 and S220, acquires the PCI at step S230, and thereby achieves synchronization with a specific cell that is currently available for the repeater 200 in the time/frequency domain. That is, the reference detector 230 is synchronized with the cell for which the SS is detected. Therefore, the repeater 200 may obtain a time instance of a physical broadcast channel (PBCH).

Subsequently, at step S240, the reference detector 230 detects a synchronization signal block (SSB) index by correlating the received signal (i.e., SSB) with a demodulation reference signal (DMB) of the PBCH.

Then, at step S250, the reference detector 230 extracts a master information block (MIB) from the PBCH. Because the base station 100 performs polar coding in order to transmit the PBCH, the reference detector 230 can extract the MIB by performing polar decoding of the PBCH.

Then, at step S260, the reference detector 230 detects a frame start position (FS) through information contained in the MIB.

As described above, when the frame start position (FS) is detected, it is possible to know the positions of DL and UL symbols through the resource allocation information. Therefore, the switching controller 250 is capable of switching the switch in accordance with the DL symbol section and the UL symbol section.

Meanwhile, the above-described methods (or operations) according to various embodiments of the disclosure may be implemented as instructions stored in a non-transitory computer-readable recording medium in a programming module form. When the instructions are executed by a processor, the processor may execute a function corresponding to the instructions. The non-transitory computer-readable recording medium may include magnetic media such as a hard disk, a floppy disk, and a magnetic tape, optical media such as a compact disc read only memory (CD-ROM) and a digital versatile disc (DVD), magneto-optical media such as a floptical disk, and hardware devices specially configured to store and perform a program instruction. In addition, the program instructions may include high class language codes, which can be executed in a computer by using an interpreter, as well as machine codes made by a compiler. The hardware devices described above may be configured to operate as one or more software modules to perform the operations of the various embodiments, and vice versa.

While this disclosure has been particularly shown and described with reference to non-limiting embodiments thereof, it will be understood by those skilled in the art that various changes in form and details may be made therein without departing from the scope of the present disclosure as defined by the appended claims.

What is claimed is:

1. A synchronization extracting apparatus comprising:
a reference detector configured to detect a start position of a radio frame from a signal broadcasted by a base station; and
a synchronization extractor configured to collect resource allocation information and extract synchronization by acquiring a boundary between an uplink (UL) signal and a downlink (DL) signal from the resource allocation information, based on the start position of the radio frame, wherein the resource allocation information indicates information about arrangement of the UL signal and the DL signal in the radio frame.

2. The apparatus of claim 1, wherein the synchronization extractor is configured to receive the resource allocation information from a management server or a manager directly or through firmware.

3. The apparatus of claim 2, wherein the management server is one of an element management system (EMS) and a self-optimization network (SON) server.

4. The apparatus of claim 1, wherein the resource allocation information includes at least one of a number of DL slots, a number of DL symbols, a number of UL slots, a number of UL symbols, a time division duplex (TDD) transmission periodicity, and an absolute radio-frequency channel number (ARFCN).

5. The apparatus of claim 1, wherein the resource allocation information includes at least one of:
a periodicity of a DL-UL pattern (dl-UL-TransmissionPeriodicity),
a number of consecutive full DL slots at a beginning of each DL-UL pattern (nrofDownlinkSlots),
a number of consecutive DL symbols in a beginning of a slot following a last full DL slot (nrofDownlinkSymbols),
a number of consecutive full UL slots at an end of each DL-UL pattern (nrofUplinkSlots), and
a number of consecutive UL symbols in an end of a slot preceding a first full UL slot (nrofUplinkSymbols).

6. The apparatus of claim 1, wherein the reference detector is configured to synchronize with a specific cell for which a synchronization signal is detected, to extract a master information block (MIB) by decoding a physical broadcast channel (PBCH) of the specific cell, and to detect the start position of the radio frame through information contained in the MIB.

7. The apparatus of claim 1, wherein the synchronization extracting apparatus comprises a field programmable gate array (FPGA).

8. The apparatus of claim 1, further comprising:
a first antenna configured to communicate with the base station;
a second antenna configured to communicate with a user terminal;
a switch configured to connect the first and second antennas to a DL processor or an UL processor;
the DL processor configured to receive the DL signal from the base station through the first antenna, to amplify the received DL signal by adjusting a gain, and to subsequently transmit the amplified DL signal to the user terminal through the second antenna;
the UL processor configured to receive the UL signal from the user terminal through the second antenna, to amplify the received UL signal by adjusting a gain, and to subsequently transmit the amplified UL signal to the base station through the first antenna; and
a switching controller configured to control the switch in accordance with the synchronization extracted by the synchronization extractor so as to connect the first antenna, the DL processor, and the second antenna in a DL symbol section and so as to connect the first antenna, the UL processor, and the second antenna in an UL symbol section.

9. A synchronization extracting method comprising:
at a reference detector, detecting a start position of a radio frame from a signal broadcasted by a base station;
at a synchronization extractor, collecting resource allocation information that indicates information about arrangement of an uplink (UL) signal and a downlink (DL) signal in the radio frame; and
at the synchronization extractor, extracting synchronization by acquiring a boundary between the UL signal and the DL signal from the resource allocation information, based on the start position of the radio frame.

10. The method of claim 9, wherein the collecting includes:
at the synchronization extractor, receiving the resource allocation information corresponding to a synchronization signal block index from a management server; or
at the synchronization extractor, receiving the resource allocation information entered by a manager directly or through firmware.

11. The method of claim 10, wherein the management server is one of an element management system (EMS) and a self-optimization network (SON) server.

12. The method of claim 9, wherein the resource allocation information includes at least one of a number of DL slots, a number of DL symbols, a number of UL slots, a number of UL symbols, a time division duplex (TDD) transmission periodicity, and an absolute radio-frequency channel number (ARFCN).

13. The method of claim 9, wherein the resource allocation information includes at least one of:
a periodicity of a DL-UL pattern (dl-UL-TransmissionPeriodicity),
a number of consecutive full DL slots at a beginning of each DL-UL pattern (nrofDownlinkSlots),
a number of consecutive DL symbols in a beginning of a slot following a last full DL slot (nrofDownlinkSymbols),
a number of consecutive full UL slots at an end of each DL-UL pattern (nrofUplinkSlots), and
a number of consecutive UL symbols in an end of a slot preceding a first full UL slot (nrofUplinkSymbols).

14. The method of claim 9, wherein the detecting includes:
at the reference detector, synchronizing with a specific cell for which a synchronization signal is detected;
at the reference detector, extracting a master information block (MIB) by decoding a physical broadcast channel (PBCH) of the specific cell; and
at the reference detector, detecting the start position of the radio frame through information contained in the MIB.

15. The method of claim 9, wherein the reference detector and the synchronization extractor are implemented through a field programmable gate array (FPGA).

16. The method of claim 9, further comprising:
at a switching controller, controlling the switch in accordance with the synchronization extracted by the synchronization extractor to:
connect a first antenna, a DL processor, and a second antenna in a DL symbol section such that the DL processor receives the DL signal from the base station through the first antenna and transmits the received DL signal to a user terminal through the second antenna, and
connect the first antenna, an UL processor, and the second antenna in an UL symbol section such that the UL processor receives the UL signal from the user terminal through the second antenna and transmits the received UL signal to the base station through the first antenna.
